(19) United States
(12) Patent Application Publication
(10) Pub. No.: US 2013/0061220 A1
(43) Pub. Date: Mar. 7, 2013

(54) METHOD FOR ON-DEMAND INTER-CLOUD LOAD PROVISIONING FOR TRANSIENT BURSTS OF COMPUTING NEEDS

(71) Applicants: Shanmuganathan GNANASAMBANDAM, Victor, NY (US); Steven J. HARRINGTON, Webster, NY (US)

(72) Inventors: Shanmuganathan GNANASAMBANDAM, Victor, NY (US); Steven J. HARRINGTON, Webster, NY (US)

(73) Assignee: Xerox Corporation, Norwalk, CT (US)

(21) Appl. No.: 13/225,868

(22) Filed: Sep. 6, 2011

(51) Int. Cl. G06F 9/455

(52) U.S. Cl. 718/1

(57) ABSTRACT

A method for provisioning computing resources for handling bursts of computing power including creating at least one auxiliary virtual machine in a first cloud of a first plurality of interconnected computing devices having at least one processor, suspending the at least one auxiliary virtual machine, receiving a burst job requiring processing in a queue associated with at least one active virtual machine, transferring a workload associated with the queue from the at least one active virtual machine to the at least one auxiliary virtual machine, resuming the at least one auxiliary virtual machine, and processing the workload with the at least one auxiliary virtual machine.

### INCORPORATION BY REFERENCE

The following co-pending applications are incorporated herein by reference in their entireties: U.S. patent application Ser. Nos. 12/760,920, filed Apr. 15, 2010 and 12/876,623, filed Sep. 7, 2010.

### TECHNICAL FIELD

The presently disclosed embodiments are directed to providing a system and method for the provisioning of computational resources in a computer cloud, and, more particularly, to providing a system and method of efficiently handling transient bursts of demand for computer processing resources.

### BACKGROUND

Cloud computing is known in the art as becoming increasingly popular for efficiently distributing computer resources to entities which would otherwise not have access to large amounts of processing power. Among many other things, for example, cloud computing has been utilized as one solution to accommodate situations in which an entity (e.g., a company, individual, etc.) connected to a cloud of inter-connected computers requests a task or job to be completed that requires a large amount of computational processing power and that must be completed in a relatively short amount of time (a “burst” job). However, even with the generally more efficient resource management provided by cloud computing, it remains difficult to predict, maintain and/or provision for such burst demands of computational power.

For example, a sudden need of computational power for some kinds of real-time analysis, such as constructing a document redundancy graph or performing cross document paragraph matching, results in a burst of computational activity requiring a corresponding burst of computational processing power. That is, these burst jobs may be of short duration but require an extremely heavy processing load. “Time-sharing” of the resources of a virtual machine (VM) in a cloud is sometimes used, in which idle VMs associated with a first user or entity are used for processing burst loads from a second user or entity. Time-sharing between VMs is often impractical, however, due to security concerns, namely, the potential sharing of confidential information between two parties in the same cloud (e.g., the data from a first party cannot be processed using the processor of a second party because there is a risk that the second party could access, save, or copy the first party's data from the processor, temporary or log files associated with the processor, etc.). While on-demand scaling of the parameters of a virtual machine (e.g., memory, processing power, storage, etc.) in a cloud is typically used to provide flexibility to users in the cloud, it can take up to a few minutes (say, 3-4 minutes) to spin up or activate a new virtual machine to provide additional resources. Thus, scaling on-demand by spinning up additional VMs is impractical for burst computations which must be completed in less than a few minutes (i.e., <3-4 minutes) in order to meet quality of service (QoS) requirements, because the demand will disappear before a virtual machine has a chance to even start up. Some entities may handle burst processing needs by using an always-on approach, in which all virtual machines and all possible computational resources are always available. However, for many entities, bursts occur rarely enough (e.g., once an hour, day, week, etc.) to make the always-on approach inefficient and costly except for entities or organizations having large data centers (e.g., Google, Amazon, Microsoft, etc.). Thus, there is need for computational techniques that provision computing resources for burst loads in a cost-effective and secure manner while respecting QoS requirements.

### SUMMARY

Broadly, the methods discussed infra provide provisioning of computational or processing power for processing burst requests within a cloud. Burst requests are common, for example, in real-time document analysis. Intense document processing demands or other burst tasks can last for merely a minute on a large set of parallel computing resources. If the analysis is performed on a small set of computing resources, it often renders the results tardy enough to be useless. If there are a large number of such demands, additional resources need to be provisioned to keep response times down for both burst and typical jobs. However, additional resources cannot be provisioned after arrival of the burst request because it would take too much time to ready any additional resources. Additional resources cannot be provisioned based on predictions of load because burst tasks are inherently intermittent and transient. Such load has to be managed by using inter-cloud workload provisioning (over a number of clouds) and/or live migration of running workload. These methods are most applicable to companies that are averse to using permanent, always-on, or dedicated data centers for providing analysis workload.

According to aspects illustrated herein, there is provided a method for provisioning computing resources for handling bursts of computing power including creating at least one auxiliary virtual machine in a first cloud of a first plurality of interconnected computing devices having at least one processor, suspending the at least one auxiliary virtual machine, receiving a burst job requiring processing in a queue associated with at least one active virtual machine, transferring a workload associated with the queue from the at least one active virtual machine to the at least one auxiliary virtual machine, resuming the at least one auxiliary virtual machine, and processing the workload with the at least one auxiliary virtual machine.

According to other aspects illustrated herein, there is provided a method for provisioning computing resources to accommodate for bursts of processing power demand for at least one virtual machine including providing at least one virtual machine in a cloud wherein at least one processor is associated with the at least one virtual machine, and the at least one processor alternates between a busy phase and an idle phase while processing a first job, determining when the at least one processor is in the idle phase, receiving a burst job requiring a larger amount of processing by the at least one processor per unit time in comparison with the first job, and processing at least a portion of the burst job during at least one of the idle phases of the at least one processor.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a schematic illustration of a cloud computing arrangement;

FIG. 2 is a flowchart detailing a method of rapid virtual machine shuffling; and,

FIG. 3 is a chart schematically illustrating the interleaving of a burst job with a main job in a cloud.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “cloud computing” is intended generally to mean the sharing of computer resources (e.g., memory, processing power, storage space, software, etc.) across several computers, machines, or servers through a network, such as the Internet. An evolving definition of cloud computing is provided by the National Institute of Standards and Technology. Thus, a “cloud” is generally meant to be a collection of such interconnected machines, computers, or computing devices. By “computer,” “PC,” or “computing device” it is generally meant any analog or digital electronic device which includes a processor, memory, and/or a storage medium for operating or executing software or computer code. By “virtual” or “virtual machine” it is meant a representation of a physical computer, such as having an operating system (OS) accessible by a user and usable by the user as if it were a physical machine, wherein the computing resources (e.g., memory, processing power, software, storage, etc.) are obtained from a shared pool of resources, such that each virtual machine may be a collection of resources from various inter-connected computing devices, or alternatively, may be a sub-set of resources from a single computing device. Virtual machines may be accessible internally or externally. As used herein, “external” or an “external cloud” is intended to mean at least one computer arranged in a different location than the entity requesting the computation to be performed. As used herein, “internal” or an “internal cloud” is intended to mean at least one computer arranged in the same location as the entity requesting the computing to be performed, including a plurality of computers interconnected to each other and the entity requesting the computation to be performed. As used herein, “inter-cloud” or “intercloud” may generally be used as an adjective to refer to having the quality or nature of multiple connected clouds or being communicated or transferred between clouds; or, as a noun to refer to an inter-connected cloud (or group) of clouds. A “burst” or “burst job” as used herein particularly refers to a computer job, task, request, or query that requires a relatively large amount of processing power that must be completed in a short amount of time. Alternatively stated, a burst job required a relatively large amount of processing per unit time for completion of the burst job in comparison to typical jobs. “Burst” also more generally reflects the nature of any job which a computer, cloud, or processor is unable to handle alone, and that must be “bursted” out to other computers, VMs, or processors in an internal cloud, or out to an external cloud, to meet quality of service requirements.

Moreover, although any methods, devices or materials similar or equivalent to those described herein can be used in the practice or testing of these embodiments, some embodiments of methods, devices, and materials are now described.

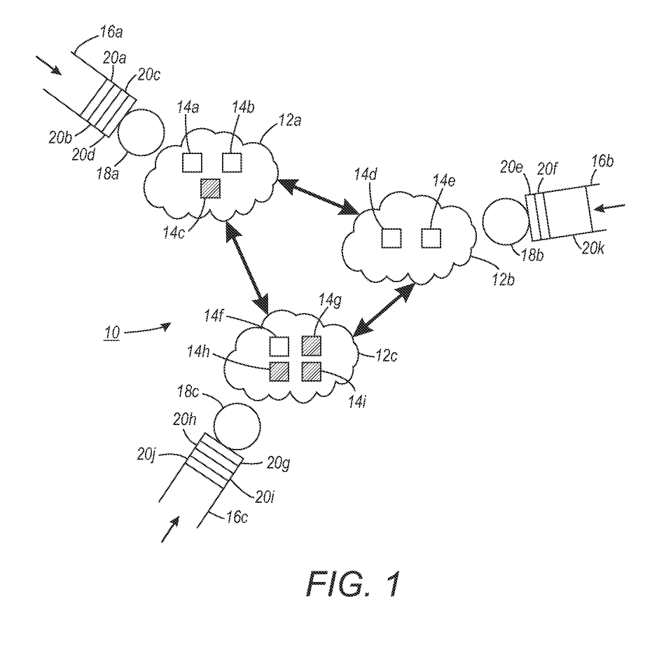

Referring now to the Figures, FIG. 1 shows cloud 10 which comprises components 12a, 12b and 12c, having machines 14a-14i. It should be appreciated that due to the nature of clouds, computers, virtual machines, and shared resources, FIG. 1 schematically represents a variety of arrangements, depending on what is referred to by each reference numeral. In general, cloud 10 includes a plurality of components 12a-12c that further corresponds to a plurality of machines 14a-14i. That is, each component could be an individual computer in cloud 10, or each component could represent a data center or collection of interconnected computers (i.e., a cloud) in cloud 10. That is, it is immaterial if components 12a-12c are connected in a single internal cloud, or connected externally in a larger intercloud. Furthermore, machines 14a-14i could be processors or virtual machines associated with components 12a-12c. For example, in one embodiment cloud 10 could depict a single cloud of shared resources, with components 12a-12c depicting individual computers within the cloud, with machines 14a-14i representing processors or multiple processor cores in the computers, or virtual machines accessible within the cloud and associated with a certain amount of processing power, etc. Regardless, it should be appreciated that FIG. 1 represents generally a cloud-computing arrangement wherein at least one cloud is formed having at least one computer, with the computer(s) including at least one processor and other resources, and the processing power of the at least one processor associated with at least one virtual machine.

Queues 16a-16c are also shown schematically in FIG. 1, which queues are handled by control modules 18a-18c, respectively. The queues contain a number of computing tasks or jobs 20a-20k. The control modules represent the software and hardware necessary to manage the shared resources and queues and ensure that the jobs are handled by utilizing the correct resources (e.g., the resources are associated with the correct VMs and handled by the processor(s) associated with those VMs). For example, control modules 18a-18c may include hypervisors or virtual machine monitors (VMMs) for enabling multiple operating systems to run concurrently on a single computer and for allocating physical resources between the various virtual machines.

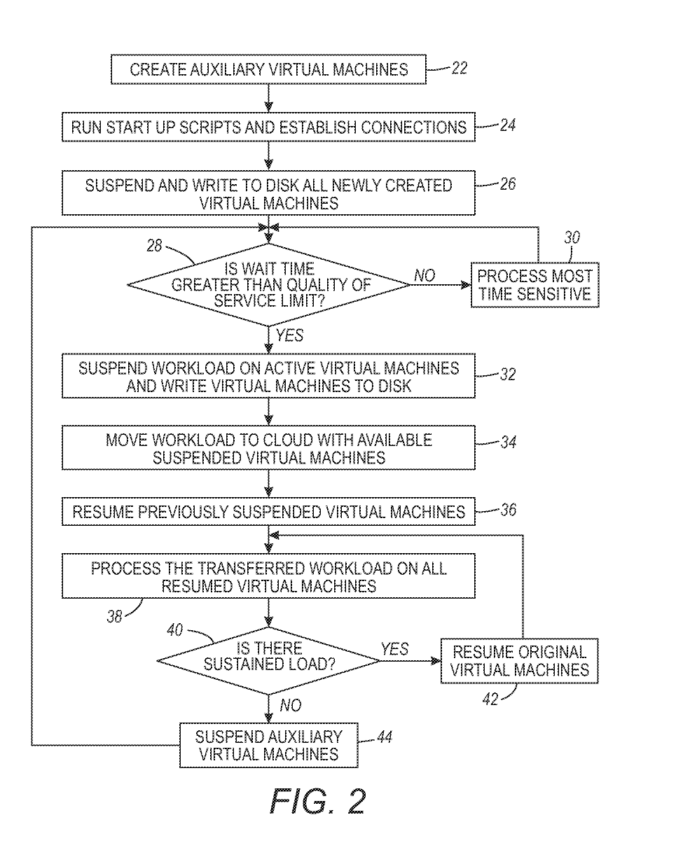

In many scenarios, it is unacceptable that extra VMs are started only to wait permanently for additional overflow queries (e.g., an always-on scheme), as this is wasteful of resources. FIG. 2 introduces a concept of rapid VM shuffling, which has much lower latency or response time than starting a new VM. This scheme is also advantageously utilized if there are security or ownership concerns with respect to the data being processed, and therefore “timesharing” of VMs is not allowed (that is, for example, a VM for a first party is not allowed to process data from a second party, because the second party does not want their data accessible by any other party). For the following discussion of rapid VM shuffling, machines 14a-14i in FIG. 1 shall be considered to represent virtual machines, although it is immaterial whether each component 12a-12c is an individual computer, or a cloud of computers. That is, the currently described methods could be internally performed in a single cloud, or externally performed between clouds in an intercloud.

As shown in FIG. 2, a number of “auxiliary” VMs are first initialized (step 22), a process which generally takes approximately four minutes to complete per VM, although the process can be done in parallel. It should be appreciated that the number of VMs could be hundreds, or more if necessary, but the startup time would essentially remain the same regardless of the number of the VMs that are initialized because this can be done in parallel. The term “auxiliary” is used merely for identification purposes herein to differentiate between the originally suspended VMs from the originally active VMs. The auxiliary and active VMs otherwise substantially resemble each other. After initialization, any required start up scripts are run to establish connections between the auxiliary VMs (step 24). For example, the auxiliary VMs could be made available for parallel processing with the other auxiliary and active VMs in the cloud. Any known parallel processing software, including the Apache Hadoop MapReduce, could be used to set up the VMs. After all necessary connections are established and start up scripts are run, the auxiliary VMs are suspended and written to a hard disk or other storage medium (step 26). The VMs not suspended are referred to as the active VMs, and these active VMs handle the typical, non-burst tasks that are queued.

As jobs are requested to be performed on the active VMs, it is determined if the estimated wait time until completion for each queued job is greater than a QoS limit (step 28). The estimated wait time could be calculated or determined according to any means known in the art. For example, a control unit could take a summation of the size of all data that needs to be processed for completion of each job, and divide that sum by a known or empirically calculated average rate by which the active machines can process data per unit time in order to determine how long it will take the active VMs to complete each job in the queue. Regardless of how the estimated wait time is determined, the jobs are processed according to whichever job is the most time sensitive (step 30). By most time sensitive it is meant, for example, the job which is most at risk of not being timely completed. Alternatively or in addition, step 30 may include sending newly received tasks to the queue that is determined to have the shortest overall estimated wait time in step 28, so that heavily loaded queues do not get overloaded while unloaded queues remain empty. It should be appreciated that some other method or measure could be used to determine which job should be processed next in step 30 (e.g., “first-in, first-out”, “last-in, first-out”, smallest data size, other QoS measures, etc.). To ensure QoS requirements are not missed, step 28 could be run continuously or repeatedly.

If the wait time is determined to be impermissibly long, particularly as a result of a requested burst job, then the workload in the corresponding queue is suspended, and the corresponding virtual machines are written to disk (step 32). Simultaneously, the workload is transferred to a cloud and/or a control unit in a cloud, which is associated with a sufficient number of suspended auxiliary virtual machines to timely handle the task (step 34). The transferred workload may include all of the jobs in the queue at the time the active VMs are suspended in step 32, or merely the burst job, which takes priority over the other jobs. Part of the transferred workload is the additional computing that is required to perform the transfer. It is assumed that data communication in the cloud is sufficient for large data transfers, such as over a 10 Gigabit Ethernet system. Further, it is assumed that the jobs are processing intensive (such as many small html files) and not data intensive (such as processing large numbers of high-resolution tiff or other images).

The auxiliary VMs are then resumed from their suspended state and reinitialized and/or resynchronized with the other machines in the cloud (step 36). While steps 32, 34, and 36 are shown occurring sequentially, but it should be appreciated that these steps could occur simultaneously or in any other order. Typically, VMs can be resumed from a suspended state, resynchronized in the cloud, and ready for parallel computing within about ten seconds because all of the startup scripts have already been run to establish connections between the VMs in step 24. After the suspended VMs are resumed, the transferred workload is processed in parallel using the newly resumed VMs (step 38).

Next, it is checked to see whether there is a sustained load on the auxiliary VMs (step 40). If there is a sustained load (e.g., additional queries and/or jobs that must be processed immediately), then the original VMs can be resumed (step 42), and utilized for processing the transferred workload, the additional queries, the original jobs if only the burst job was transferred to the auxiliary VMs, etc. Alternatively, the original VMs could be restarted on a different set of machines for a different purpose entirely, such as to handle a new burst job from a different set of machines, while the auxiliary machines process all additional workload. If there is not a sustained load, then any unneeded auxiliary machines can be re-suspended, until they are needed at a later time (step 44). In this way, in some embodiments the active VMs can become auxiliary VMs that are suspended and waiting for typical or burst jobs that need processing, while auxiliary VMs can become active VMs for handling the processing of common non-burst tasks within the cloud. In other embodiments the auxiliary VMs are only used for processing burst loads on an as-needed basis and are re-suspended after processing each burst job.

For example, one scenario is now described with respect to FIGS. 1 and 2, which scenario is intended for the sake of describing aspects of the invention only and should not be interpreted as limiting the scope of the claims in any way. For this example, shaded machines 14c, 14g, 14h, and 14i represent the auxiliary VMs, while un-shaded machines 14a, 14b, 14d, 14e, and 14f represent the active or original VMs. It should be appreciated that while only a few VMs are shown in FIG. 1, the currently described methods could be used by essentially any number of VMs. According to the method of FIG. 2, auxiliary virtual machines 14c, 14g, 14h, and 14i are first created associated with their respective components 12a-12c, scripts are run to establish necessary connections, and the auxiliary virtual machines and written to disk in steps 22, 24, and 26. Components 12a-12c are associated with queues 16a-16c and control modules 18a-18c for allocating the resources of the virtual machines and managing jobs 20a-20k so that the jobs are completed according to QoS requirements. In this example, jobs 20a-20j are shown as taking up only thin slivers along the length of queues 16a-16c, indicating that jobs 20a-20j are quick jobs that require little data processing (e.g., typical non-burst jobs). However, job 20k is an example of a “burst” job, that takes a large amount of processing power to complete, and therefore is shown occupying a substantial portion of queue 16b.

Thus, in this scenario, it could be determined in step 28 by control units 18a and 18c that the estimated wait time for jobs 20a-20d in queue 16a and jobs 20g-20j in queue 16c are satisfactory to meet QoS requirements, and therefore the jobs are be processed according to whichever job is the most time sensitive (or by whichever other metric or method is desired) in step 30. In this scenario, it could be also be determined by control unit 18b in step 28 that component 12b will not be able to timely complete job 20k if processed by only machines 14d and 14e, due to the large processing requirements.

Accordingly, in this example, control unit 18b would proceed to step 32. For component 12b, virtual machines 14d and 14e would be suspended in step 32 and the workload transferred in step 34 to component 12c, where there are more available suspended VMs, specifically, machines 14g, 14h, and 14i. This workload could include every job in queue 16b at the time (i.e., jobs 20e, 20f, and 20k) or just the burst job (i.e., job 20k) These resumed machines would then process the transferred workload in step 38. Control unit 18c would monitor queue 16c to see if there is sustained load for resumed VMs 14g, 14h, and 14i in step 40. If there is no sustained load, then any workload could be resumed on machines 14d and 14e, which are resumed in step 42, while the auxiliary machines are suspended in step 44 when they are no longer needed.

Alternatively, just a portion of the resumed auxiliary machines could be re-suspended, for example, one of machines 14g, 14h, or 14i, and the two remaining machines used to process the jobs that would have otherwise have been processed by machines 14d and 14e. As previously mentioned, the now-suspended machines which were originally active (e.g., machines 14d and 14e) could be used as auxiliary machines to handle further burst loads. For example, if it is determined by control unit 18c that machine 14f will not be able to process all of its jobs timely, the workload could be transferred to component 12b, and machines 14d and 14e resumed to process the transferred load. In this way, the VMs can be suspended, written to disk, and resumed as needed to handle burst loads from any point in cloud 10. As described previously, it should be appreciated that cloud 10 could represent a single cloud that bursts internally between computers or virtual machines within a cloud; or, cloud 10 could represent a cloud of clouds, where the jobs are bursted externally between clouds.

As discussed previously, in cloud computing arrangements, a plurality of virtual machines are established and operatively connected together to process massive amounts of data in parallel. If security concerns are not an issue, then the same virtual machines can be used to process jobs for more than one party, such that a burst job can be interleaved among a main task or plurality of smaller common tasks. That is, typically, the virtual machines are processing a main task or job, but may occasionally receive a burst job that requires a relatively large amount of processing to be completed within a short amount of time, such as discussed previously with respect to FIG. 1. It should be appreciated that the main task could be one large processing task, a batch task, or even a multitude of unrelated tasks, but that these tasks generally require little processing and are not considered burst tasks.

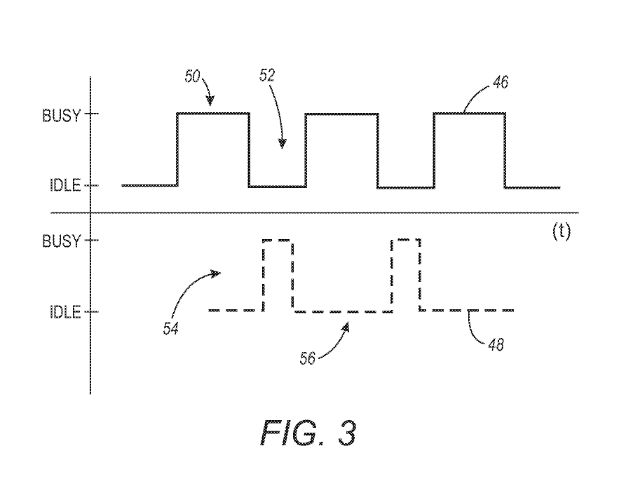

Accordingly, a method of burst-interleaving is proposed with respect to the schematic illustration of FIG. 3. Profile 46 in FIG. 3 generally represents the idle and busy status of the processors for a certain set of virtual machines that are operating in parallel with respect to the processing of a main task. This cycle of busy and idle phases is common, for example, in many parallel computing workflows, such as according to Google's MapReduce framework, in which the parallel processes cycle between a phase of parallelization and synchronization. Such cycles have a busy processing phase followed by a slack or idle phase where little to no heavy processing is performed, although there may be data transfers, such as to or from hard disks or other storage mediums. These cycles can occur simultaneously over hundreds of virtual machines connected in parallel. Thus, a supplemental task, such as a burst task, associated with profile 48, can be interleaved between the parallelization phases of the main task. That is, profile 46 alternates between crests 50 and troughs 52, during which the processor is busy processing the main task or idle during synchronization, respectively, while profile 48 similarly alternates between crests 54 and troughs 56, during which time the processor is busy processing and not processing the supplemental task, respectively.

Thus, if a certain set of virtual machines across an entire cloud can be identified that have a similar utilization profile (e.g., they all generally follow profile 46), then a supplemental burst load can be interleaved between the busy phases. That is, as shown schematically in FIG. 3, the busy phases for processing the supplemental or burst job, shown as crests 54 of profile 48 are aligned with the idle phases of the main job, are shown as troughs 52 of profile 46. Likewise, the idle phases for processing the supplemental or burst job, shown as troughs 56 of profile 48 are aligned with the busy phases of the main job, shown as crests 50 of profile 46. That is, the burst job is processed while the processors are idle with respect to the main job and then paused so that the main job can be resumed.

Furthermore, burst interleaving could be similarly performed by pairing certain kinds of workload together. For example, if the main job is a “burst accommodative” workload, such as a batch processing job comprising a plurality of smaller jobs that is going to take several hours to perform, then idle phases could be “artificially” inserted after completion of each smaller job. That is, the processors or a controller for the processors could temporarily pause processing of subsequent jobs in the batch to check for a burst job, and if one is found, to process the burst job before the remainder of the batch. These artificial pauses could be inserted every specified number of completed jobs, once per given unit of time, etc. Thus, a batch job can be artificially structured to resemble profile 46, wherein the processing of each job within the batch is represented by crests 50, while the artificially implanted pauses between jobs are represented by troughs 52. Likewise, the processing of the supplemental or burst job would resemble profile 48. Because of the predictability of competition of tasks within the batch, there can be a high level of confidence that pauses can be inserted sufficiently often to ensure that bursts are handled timely and/or to meet any other QoS requirements. Further, since the method is intended only to handle infrequent burst demands, these bursts will not unduly delay the results of the batch process. Further, it is assumed that the workloads are being processed over a large set of nodes in a cloud, so any burst job can be handled quickly by the associated processors before returning to work on the batch process.

It will be appreciated that various aspects of the above-disclosed embodiments and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for provisioning computing resources for handling bursts of computing power comprising:
(a) creating at least one auxiliary virtual machine in a first cloud of a first plurality of interconnected computing devices having at least one processor;
(b) suspending said at least one auxiliary virtual machine;
(c) receiving a burst job requiring processing in a queue associated with at least one active virtual machine;
(d) transferring a workload associated with said queue from said at least one active virtual machine to said at least one auxiliary virtual machine;
(e) resuming said at least one auxiliary virtual machine; and,
(f) processing said workload with said at least one auxiliary virtual machine.

2. The method recited in claim 1 wherein said workload is only transferred in step (d) if an estimated wait time for processing said job in said queue is determined to be longer than a quality of service limit.

3. The method recited in claim 1 wherein said active virtual machine and said auxiliary virtual machine are both in said first cloud.

4. The method recited in claim 1 wherein said active virtual machine is in a second cloud of a second plurality of interconnecting computing devices.

5. The method recited in claim 4 wherein said first cloud is an external cloud and said second cloud is an internal cloud.

6. The method recited in claim 4 wherein said first and second clouds at least partially form an intercloud.

7. The method recited in claim 1 wherein after step (c) said method further comprises:
(g) suspending said at least one active virtual machine.

8. The method recited in claim 7 wherein after step (g) said method further comprises:
(h) resuming said at least one active machine suspended in step (g); and,
(i) processing said workload, a second workload, or combinations thereof on said at least one resumed active virtual machine.

9. The method recited in claim 1 wherein said at least one auxiliary virtual machine is suspended in step (b) by writing data representing said at least one auxiliary virtual machine to a hard disk or storage medium.

10. The method recited in claim 1 wherein said queue, said at least one auxiliary virtual machine, said queue, or combinations thereof, is managed by a control unit.

11. The method recited in claim 1 wherein said at least one auxiliary virtual machine comprises a plurality of virtual machines operatively connected for processing in parallel.

12. The method recited in claim 1 wherein said at least one active virtual machine comprises a plurality of virtual machines operatively connected for processing in parallel.

13. The method recited in claim 1 further comprising, after processing of said workload in step (f):
(j) re-suspending said at least one auxiliary virtual machine

14. The method recited in claim 1 wherein a security parameter of said at least one active virtual machine prohibits timesharing of said at least one active virtual machine.

15. A method for provisioning computing resources to accommodate for bursts of processing power demand for at least one virtual machine comprising:
(a) providing at least one virtual machine in a cloud wherein at least one processor is associated with said at least one virtual machine, and said at least one processor alternates between a busy phase and an idle phase while processing a first job;
(b) determining when said at least one processor is in said idle phase;
(c) receiving a burst job requiring a larger amount of processing by said at least one processor per unit time in comparison with said first job; and,
(d) processing at least a portion of said burst job during at least one of said idle phases of said at least one processor.

16. The method recited in claim 15 wherein said at least one processor comprises a plurality of processors operatively connected for parallel processing between said processors.

17. The method recited in claim 16 wherein said busy phase corresponds to said processors parallelizing and wherein said idle phase corresponds to said processors synchronizing.

18. The method recited in claim 15 wherein said idle phase corresponds to said at least one processor during a read action from a storage medium, a write action to said storage medium, or combinations thereof.

19. The method recited in claim 15 wherein said first job is a batch job comprising a plurality of smaller jobs, and wherein a pause is implanted after processing at least one of said smaller jobs and said pause corresponds to said idle phase.

20. The method recited in claim 15 wherein said first job is associated with a first user and said burst job is associated with a second user.
